(19) United States
(12) Patent Application Publication
(10) Pub. No.: US 2026/0340891 A1
(43) Pub. Date: Oct. 29, 2026

(54) METHODS AND SYSTEMS FOR SPLINE INTERPOLATION USING CUBIC BÉZIERS AND ANGLE BISECTOR

(71) Applicant: Pentrek, Inc., Chapel Hill, NC (US)

(72) Inventor: Michael Reed, Chapel Hill, NC (US)

(21) Appl. No.: 19/380,392

(22) Filed: Nov. 5, 2025

Related U.S. Application Data
(60) Provisional application No. 63/794,572, filed on Apr. 25, 2025.

(51) Int. Cl. G06T 11/23; G06F 17/16; G06T 1/20

(52) U.S. Cl. CPC G06T 11/23; G06F 17/16; G06T 1/20

(57) ABSTRACT

A method for defining control points for cubic Bézier splines at interior knots in a sequence. For each interior knot, the method identifies a previous, current, and next knot, then computes vectors from the current knot to both adjacent knots. After normalizing these vectors, it computes a bisector direction vector by summing them, normalizes this result, and rotates it ninety degrees counter-clockwise to determine the tangent direction. The method calculates tangent lengths by projecting the original vectors onto this tangent direction using dot products. Finally, it determines control points for cubic Bézier segments before and after the current knot based on the tangent direction and computed lengths, creating smooth curves that avoid self-intersections and loops commonly found in conventional spline interpolation techniques.

### CROSS-REFERENCE TO RELATED APPLICATIONS

This application claims priority to U.S. Provisional Patent Application No. 63/794,572, filed on Apr. 25, 2025, by Pentrek, Inc., entitled “METHODS AND SYSTEMS FOR SPLINE INTERPOLATION USING CUBIC BÉZIERS AND ANGLE BISECTOR,” the entire content of which is incorporated by reference herein.

### TECHNICAL FIELD

The present disclosure relates to vector-graphics spline interpolation, and more particularly to methods and systems for spline interpolation using cubic Béziers and a tangent direction perpendicular to the bisector of the angle formed between vectors extending from each interior knot to its neighboring knots.

### BACKGROUND

Vector graphics applications rely on smooth curve interpolation techniques to generate visually appealing paths through user-specified control points. These interpolation methods must balance computational efficiency with visual quality while maintaining mathematical continuity between curve segments.

One of the challenges in spline interpolation is determining appropriate tangent vectors at interior control points that produce smooth, predictable curve behavior. Traditional interpolation methods struggle to account for the angular relationships between adjacent path segments, leading to tangent calculations that may not reflect the local geometric context around each control point.

Conventional approaches to tangent estimation can therefore produce curves that exhibit undesirable visual artifacts when the spatial arrangement of control points introduces sharp directional changes or irregular spacing patterns. These artifacts may include excessive curvature, unexpected inflection points, or curve segments that deviate from the intended path trajectory.

The computational challenge becomes more complex when dealing with composite curves that must maintain visual continuity across multiple segments while preserving the geometric intent of the original control point sequence. Existing methods can generate tangent directions that cause individual curve segments to interact poorly with neighboring curve segments, resulting in composite curves that appear discontinuous or geometrically inconsistent.

Another challenge in vector graphics spline generation involves balancing the mathematical precision of curve construction with the performance requirements of interactive design applications. Methods that require extensive computational overhead or complex parameter tuning may not be suitable for real-time editing environments where users expect immediate visual feedback.

Accordingly, a need exists for improved interpolation techniques that can reliably generate smooth curves through arbitrary control point configurations while maintaining computational efficiency and avoiding the geometric artifacts that can compromise visual quality in professional graphics applications.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one embodiment, a method of defining control points for a cubic Bézier spline at each interior knot in a sequence of knots is provided. In this embodiment, the method comprises identifying, for each interior knot in the sequence, a previous knot, a current knot, and a next knot. The method further comprises computing a first vector from the current knot to the previous knot and computing a second vector from the current knot to the next knot. The method also comprises normalizing the first and second vectors and computing a bisector direction vector by summing the normalized first and second vectors. Additionally, the method comprises normalizing the bisector direction vector and computing a tangent direction vector at the current knot by rotating the normalized bisector direction vector ninety degrees counter-clockwise. The method further comprises computing a first tangent length by projecting the first vector onto the tangent direction vector using a dot product and computing a second tangent length by projecting the second vector onto the tangent direction vector using a dot product. Finally, the method comprises determining control points for cubic Bézier segments before and after the current knot based on the tangent direction vector and the first and second tangent lengths.

In another embodiment, a computing system is provided. In this embodiment, the computing system comprises a memory storing instructions and a data structure configured to store control points, and a processor operatively coupled to the memory and configured to execute the instructions. The processor is configured to identify, for each interior knot in a sequence of knots, a previous knot, a current knot, and a next knot. The processor is further configured to compute a first vector from the current knot to the previous knot and compute a second vector from the current knot to the next knot. The processor is also configured to normalize the first and second vectors and compute a bisector direction vector by summing the normalized first and second vectors. Additionally, the processor is configured to normalize the bisector direction vector and compute a tangent direction vector at the current knot by rotating the normalized bisector direction vector ninety degrees counter-clockwise. The processor is further configured to compute a first tangent length by projecting the first vector onto the tangent direction vector using a dot product and compute a second tangent length by projecting the second vector onto the tangent direction vector using a dot product. Finally, the processor is configured to determine control points for cubic Bézier segments before and after the current knot based on the tangent direction vector and the first and second tangent lengths.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is a curve constructed using a Catmull-Rom technique, in accordance with an aspect of the present disclosure;

FIG. 2 is a composite Bézier curve with undesirable loops using the Catmull-Rom technique, in accordance with an aspect of the present disclosure;

FIG. 3 is a curve connecting points using disclosed tangent-based techniques, in accordance with an aspect of the present disclosure;

FIG. 4 is a composite Bézier curve constructed using the disclosed techniques, in accordance with an aspect of the present disclosure;

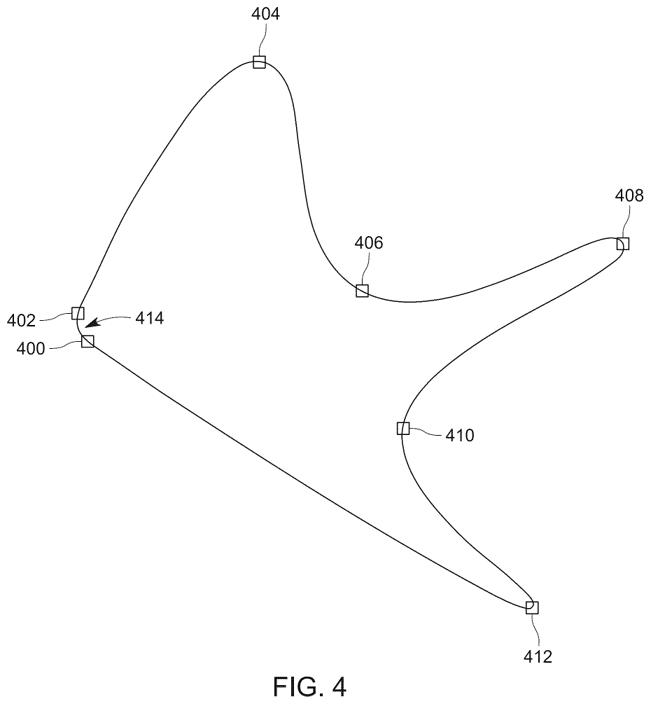

FIG. 5 is a flow chart of techniques for defining control points for cubic Bézier splines, in accordance with an aspect of the present disclosure; and

FIG. 6 is a functional block diagram of a computing system for implementing spline interpolation methods, in accordance with an aspect of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

A detailed description of systems, devices, and methods consistent with embodiments of the present disclosure is provided below. While several embodiments are described, it should be understood that disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

The disclosed spline interpolation method provides for generating smooth curves through a sequence of user-specified points using cubic Bézier segments. The method addresses limitations found in conventional spline interpolation techniques by employing a tangent calculation approach based on angle bisector geometry. Rather than computing tangent directions using traditional methods that may produce visual artifacts such as self-intersections or undesirable loops, the method determines tangent directions by calculating the perpendicular to the angle bisector formed between vectors extending from each interior knot to neighboring knots.

The method operates by processing each interior knot in a sequence of points, where each knot serves as a connection point between adjacent curve segments. For each interior knot, the method identifies the immediately preceding and following knots, computes directional vectors from the current knot to each neighboring knot, normalizes these vectors, and calculates their angle bisector. The tangent direction at each knot is determined by rotating the normalized bisector direction by ninety degrees, creating a direction that lies perpendicular to the bisector. In some embodiments, the rotation angle may be varied (e.g., between 45 and 135 degrees) to provide flexibility in tangent direction computation while maintaining the perpendicular relationship to the bisector direction.

The method determines appropriate lengths for tangent handles by projecting the original vectors onto the computed tangent direction using dot product operations. These projection lengths provide scaling factors that reflect the local spacing and angular relationships between adjacent knots. The tangent direction and computed lengths are used to position control points for cubic Bézier segments that connect adjacent knots in the sequence, maintaining smooth continuity while avoiding geometric distortions.

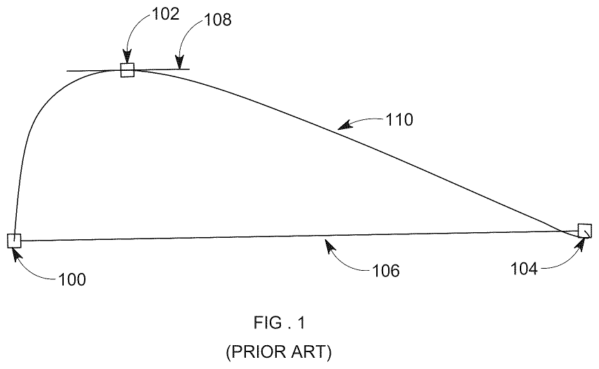

FIG. 1 depicts a simple curve constructed using a Catmull-Rom technique that illustrates a prior art technique. The illustrated example demonstrates the application of the Catmull-Rom technique to a sequence of three points where a first endpoint 100 serves as the starting point of the curve 110, while a second endpoint 104 defines the termination point. An interior point 102 lies between the first endpoint 100 and the second endpoint 104, establishing the local context for tangent vector computation. Within the Catmull-Rom framework, the interior point 102 may be designated as the “current” point, with the first endpoint 100 functioning as the “previous” point and the second endpoint 104 serving as the “next” point in the sequence.

The Catmull-Rom technique computes the tangent at the interior point 102 to be parallel to a line segment 106 connecting the first endpoint 100 and the second endpoint 104. This computational approach offers simplicity and produces visually smooth curves when points are well-behaved and approximately collinear. The line segment 106 extends between the first endpoint 100 and the second endpoint 104, providing the foundational geometric relationship that guides tangent calculation in the conventional method.

The resulting curve geometry includes several features that characterize the Catmull-Rom output. A curve peak appears near the interior point 102, representing the highest elevation of the generated curve 110 relative to the base segment 106. Following the curve peak, a descending segment of the curve 110 connects the elevated portion of the curve back toward the second endpoint 104. The curve peak and descending segment together illustrate how the Catmull-Rom tangent calculation influences the overall shape and trajectory of the interpolating curve.

The conventional Catmull-Rom approach demonstrates certain limitations, including that it does not account for the angular relationship between adjacent segments, such as the angles formed at interior knots such as the interior point 102. This can result in tangent vectors with magnitudes and directions that poorly reflect the local curvature of the intended path. When point arrangements introduce sharp changes in direction or non-uniform spacing, the resulting tangent may cause the curve to overshoot the intended path, leading to undesirable visual artifacts such as twists, inflection points, or self-intersecting loops near the interior point 102.

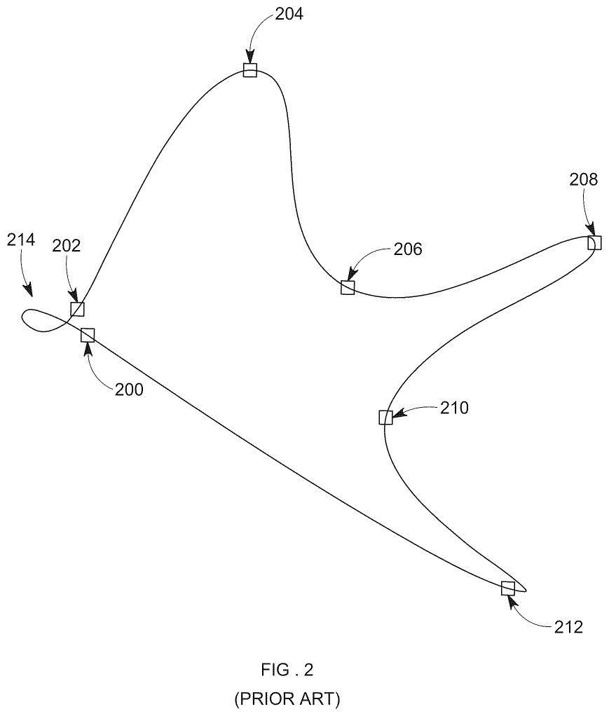

FIG. 2 illustrates a composite Bézier curve connecting the Bézier segments constructed using the Catmull-Rom technique according to various embodiments. The composite curve demonstrates the application of conventional tangent calculation methods across multiple connected segments, revealing limitations that become pronounced when the Catmull-Rom approach may be extended beyond simple three-point configurations. The figure shows how conventional methods can produce undesirable geometric artifacts when processing sequences of points with irregular spacing or sharp directional changes.

The composite curve passes through a sequence of points that includes a first knot 200, a second knot 202, a third knot 204, a fourth knot 206, a fifth knot 208, a sixth knot 210, and a seventh knot 212. Each knot in the sequence serves as both an endpoint for one curve segment and a starting point for the adjacent segment, creating continuity requirements that conventional tangent calculation methods may struggle to satisfy effectively. The spatial arrangement of these knots creates geometric challenges that expose the limitations of the Catmull-Rom technique when applied to composite curve generation.

The Catmull-Rom method processes each interior knot by computing tangent directions based on the line connecting the previous and next points in the sequence. For the second knot 202, the tangent calculation considers the relationship between the first knot 200 and the third knot 204, generating a tangent direction that may be parallel to the chord connecting these two points. This approach fails to account for the angular relationship between the incoming segment from the first knot 200 and the outgoing segment toward the third knot 204, potentially creating tangent directions that do not reflect the local geometric context at the second knot 202.

A curve segment 214 connects the first knot 200 and the second knot 202 and demonstrates the problematic results that can emerge from conventional tangent calculation approaches. The curve segment 214 exhibits a pronounced self-intersecting loop that creates an undesirable visual artifact in the composite curve. This looping effect results from the tangent direction computed at the second knot 202 deviating substantially from the intended path direction, causing the curve to overshoot and cross back over the curve segment 214. The loop formation illustrates how conventional methods can generate control points that produce Bézier segments with excessive curvature or inappropriate directional changes.

The self-intersection in the curve segment 214 occurs because the Catmull-Rom technique computes tangent magnitudes and directions without considering the angular relationship between adjacent segments at interior knots. When the angle between the incoming and outgoing directions at the second knot 202 creates a sharp change in path direction, the conventional tangent calculation may produce control points that extend too far from the knot position or point in directions that conflict with the intended curve trajectory. The resulting Bézier segment curves away from the direct path between the first knot 200 and the second knot 202, creating the loop before returning to approach the second knot 202 from an unintended direction.

The geometric distortion demonstrated by the curve segment 214 becomes more pronounced when the spatial relationship between consecutive knots creates irregular patterns or when the sequence includes abrupt directional changes. The conventional approach treats each interior knot independently, computing tangents based solely on the positions of the previous and next knots without considering the broader geometric context of the curve sequence. This limitation can propagate artifacts throughout the composite curve, as each problematic segment influences the positioning and shape of adjacent segments through shared endpoints and continuity constraints.

The problems illustrated in the curve segment 214 extend beyond simple visual appearance concerns, as self-intersecting loops can create computational challenges in applications that rely on well-behaved curve geometry. Graphics rendering systems may encounter difficulties when processing curves with self-intersections, potentially leading to rendering artifacts or performance degradation. Similarly, applications that use curves for path planning or motion control may experience unpredictable behavior when curve segments include loops or excessive curvature variations that deviate from the intended smooth trajectory between specified knots.

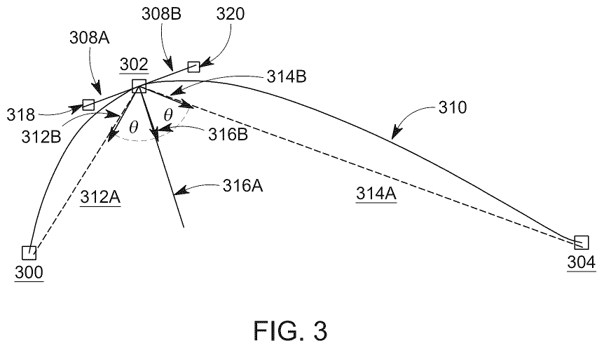

FIG. 3 illustrates a curve connecting a sequence of points constructed using the disclosed method which provides an improved approach for computing tangent directions that addresses the limitations observed in conventional spline interpolation techniques. The method uses angle bisector geometry to determine tangent directions that better reflect the local geometric relationships between adjacent curve segments, thereby reducing the occurrence of visual artifacts such as self-intersections and undesirable loops.

The illustrated configuration demonstrates the application of the disclosed technique to a three-point sequence that establishes the geometric context for tangent computation. A previous knot 300 serves as the first point in the local sequence, providing the reference position for incoming segment direction calculation. A current knot 302 functions as the central point where tangent direction computation occurs, representing the location where control points for adjacent Bézier segments may be determined. A next knot 304 completes the three-point configuration, establishing the reference position for outgoing segment direction calculation. The previous knot 300, current knot 302, and next knot 304 may be defined by user-specified coordinates in a two-dimensional space, allowing interactive specification of curve geometry through point placement operations.

The disclosed method begins tangent computation by establishing directional relationships between the current knot 302 and the adjacent points in the sequence. A first raw vector 312A extends from the current knot 302 to the previous knot 300, capturing the direction and magnitude of the incoming segment at the current knot 302. The first raw vector 312A represents the geometric relationship between the current knot 302 and the preceding point in the sequence, providing directional information that influences tangent calculation. A second raw vector 314A extends from the current knot 302 to the next knot 304, establishing the direction and magnitude of the outgoing segment at the current knot 302. The second raw vector 314A captures the geometric relationship between the current knot 302 and the following point in the sequence, completing the directional context for tangent computation.

The method processes the computed vectors through normalization operations that isolate directional information from magnitude considerations. A first normalized vector 312B results from normalizing the first raw vector 312A, creating a unit vector that preserves the direction from the current knot 302 to the previous knot 300 while eliminating magnitude variations that could distort subsequent calculations. The first normalized vector 312B provides a standardized representation of the incoming direction that enables accurate angle bisector computation. A second normalized vector 314B results from normalizing the second raw vector 314A, generating a unit vector that maintains the direction from the current knot 302 to the next knot 304 while removing magnitude influences. The second normalized vector 314B establishes a standardized representation of the outgoing direction that contributes to angle bisector determination.

The angle bisector calculation forms the foundation for the improved tangent computation approach disclosed herein. A bisector direction vector 316A may be computed by summing the first normalized vector 312B and the second normalized vector 314B, creating a vector that points in the direction of the geometric angle bisector between the incoming and outgoing directions at the current knot 302. The bisector direction vector 316A represents the directional midpoint between the normalized input vectors, providing a reference direction that reflects the angular relationship between adjacent segments. The method further processes the bisector direction vector 316A through normalization to produce a normalized bisector vector 316B that maintains the bisector direction while ensuring unit magnitude for subsequent rotation operations.

The disclosed technique determines tangent direction by computing a perpendicular to the normalized bisector vector 316B through a rotation transformation. Computing the tangent direction vector comprises applying a transformation that maps a vector (x, y) to (−y, x) to rotate the normalized bisector vector 316B ninety degrees counter-clockwise. This rotation operation creates a tangent direction that lies perpendicular to the angle bisector, providing a direction that better reflects the local geometric configuration at the current knot 302 compared to conventional tangent calculation methods. The perpendicular relationship between the tangent direction and the angle bisector helps ensure that the resulting tangent direction accommodates the angular relationship between incoming and outgoing segments while maintaining appropriate directional characteristics for smooth curve generation.

The tangent direction vector may be divided into two segments that extend in opposite directions from the current knot 302 to establish control point positions for adjacent Bézier segments. A first tangent segment 308A extends from the current knot 302 in the tangent direction toward the previous knot 300, terminating at a first control point 318 that defines the control handle for the incoming Bézier segment. The first tangent segment 308A provides the geometric basis for positioning the control point that influences the curvature of the curve segment approaching the current knot 302. A second tangent segment 308B extends from the current knot 302 in the tangent direction toward the next knot 304, terminating at a second control point 320 that establishes the control handle for the outgoing Bézier segment. The second tangent segment 308B determines the control point position that affects the curvature of the curve segment departing from the current knot 302.

The method determines the lengths of the first tangent segment 308A and the second tangent segment 308B through projection operations that relate the original vector magnitudes to the computed tangent direction. The first tangent length may be computed by projecting the first raw vector 312A onto the tangent direction vector using a dot product operation, yielding a scalar value that reflects the component of the first raw vector 312A that aligns with the tangent direction. The second tangent length may be computed by projecting the second raw vector 314A onto the tangent direction vector using a dot product operation, producing a scalar value that represents the component of the second raw vector 314A that corresponds to the tangent direction. These projection lengths provide scaling factors that position the first control point 318 and the second control point 320 at appropriate distances from the current knot 302 along the tangent direction.

A Bézier curve segment 310 demonstrates the smooth curve geometry that results from applying the disclosed tangent calculation method to generate control points for cubic Bézier interpolation. The Bézier curve segment 310 connects adjacent knots in the sequence using the first control point 318 and the second control point 320 to define the curvature characteristics of the interpolating curve. The geometric properties of the angle bisector-based tangent calculation contribute to the smooth appearance of the Bézier curve segment 310, which avoids the self-intersecting loops and excessive curvature variations that can occur with conventional tangent estimation approaches. The Bézier curve segment 310 illustrates how the disclosed method generates visually smooth curve segments that maintain appropriate curvature relationships while interpolating the specified knot positions.

The method determines control point positions through projection operations that establish appropriate tangent handle lengths based on the geometric relationships between adjacent knots. The first tangent length is computed by projecting the first raw vector onto the tangent direction vector using a dot product operation, while the second tangent length is computed by projecting the second raw vector onto the tangent direction vector. These projection operations capture the extent to which the incoming and outgoing segment directions correspond to the tangent direction, providing length measurements that reflect the geometric relationships within the computed tangent orientation.

The computed tangent lengths may be processed through adjustment operations such as scaling by a user-defined parameter for interactive curve tightness control, or equalization to the lesser of the two lengths to create symmetric control handle configurations. Control point positioning utilizes the computed tangent direction and processed tangent lengths to establish precise locations that influence the curvature of adjacent Bézier segments while maintaining directional alignment with the computed tangent direction.

The positioned control points enable generation of cubic Bézier segments that connect adjacent knots while maintaining smooth curvature characteristics. The generation process creates connected curve segments that maintain continuity at shared knot positions while exhibiting smooth curvature transitions throughout the composite curve. The resulting curves are compatible with standard Bézier curve representations and may be encoded in scalable vector graphics file formats for use in various applications.

The composite curve passes through a sequence of points that includes a first knot 400, a second knot 402, a third knot 404, a fourth knot 406, a fifth knot 408, a sixth knot 410, and a seventh knot 412. Each knot in the sequence serves as both an endpoint for one curve segment and a starting point for the adjacent segment, creating continuity requirements that the disclosed tangent calculation method addresses through the angle bisector-based approach. The spatial arrangement of these knots creates geometric configurations that demonstrate the effectiveness of the disclosed technique in handling various point distributions and angular relationships between adjacent segments. The first knot 400 through the seventh knot 412 may be defined by user-specified coordinates in a two-dimensional space, allowing interactive specification of curve geometry through point placement operations in graphics applications or design software.

The disclosed method processes each interior knot in the sequence by applying the angle bisector-based tangent calculation approach described in connection with the previous knot 300, the current knot 302, and the next knot 304. For each interior knot position, such as the second knot 402, the method computes directional vectors to the adjacent knots, normalizes these vectors to isolate directional information, and calculates the angle bisector between the incoming and outgoing directions. The tangent direction at each knot may be determined by rotating the normalized bisector direction by ninety degrees, creating a direction that lies perpendicular to the bisector and better reflects the local geometric context compared to conventional tangent calculation methods. The method determines appropriate control point positions through projection operations that establish tangent handle lengths based on the dot product relationships between the original vectors and the computed tangent direction.

A curve segment 414 connects the first knot 400 and the second knot 402, demonstrating the smooth curve geometry that results from applying the disclosed tangent calculation method to generate control points for cubic Bézier interpolation. The curve segment 414 exhibits smooth curvature characteristics that avoid the self-intersecting loops and excessive directional changes that can occur with conventional tangent estimation approaches. The geometric properties of the angle bisector-based tangent calculation contribute to the well-behaved appearance of the curve segment 414, which maintains appropriate curvature relationships while interpolating between the first knot 400 and the second knot 402. The curve segment 414 illustrates how the disclosed method generates visually smooth curve segments that accommodate angular relationships between adjacent segments without introducing geometric distortions or visual artifacts.

The smooth characteristics of the curve segment 414 contrast with the problematic results demonstrated by the curve segment 214 in the composite curve constructed using conventional Catmull-Rom techniques. The curve segment 214 exhibited a pronounced self-intersecting loop that created undesirable visual artifacts due to tangent directions computed without considering the angular relationship between incoming and outgoing segments at interior knots. The conventional approach generated control points that produced excessive curvature and inappropriate directional changes, causing the curve to overshoot and cross back over the curve segment 214. The absence of such geometric distortions in the curve segment 414 demonstrates the effectiveness of the disclosed angle bisector-based approach in generating control points that produce well-behaved Bézier segments even when point configurations create challenging angular relationships.

The composite curve generation process applies the disclosed method iteratively across all interior knots in the sequence from the second knot 402 through the sixth knot 410, with each knot serving as the current knot for tangent calculation purposes during the respective iteration. The method computes angle bisectors and perpendicular tangent directions at each interior knot position, determining control point locations that define the curvature characteristics of adjacent Bézier segments. The iterative application creates a series of connected cubic Bézier segments that share endpoints at knot positions while maintaining smooth curvature transitions throughout the composite curve. The shared endpoints ensure positional continuity between adjacent segments, while the tangent-based control point positioning provides directional continuity that contributes to smooth visual appearance across segment boundaries.

The resulting composite Bézier curve connecting the Bézier segments demonstrates the advantages of repeating the disclosed method for each interior knot in the sequence. The composite curve maintains smooth continuity throughout the path defined by the first knot 400 through the seventh knot 412, avoiding the geometric distortions and self-intersecting artifacts that can propagate through conventional spline interpolation approaches. Each segment in the composite curve benefits from control points positioned using the angle bisector-based tangent calculation, creating local curvature characteristics that reflect the geometric relationships between adjacent knots while contributing to the overall smooth appearance of the complete curve. The composite curve generation process accommodates various point spacing patterns and angular configurations without introducing visual artifacts or computational instabilities.

The composite Bézier curve does not include self-intersections or loops near the knots, demonstrating a fundamental advantage of the disclosed tangent calculation approach over conventional methods. The absence of self-intersecting geometry results from the angle bisector-based tangent directions that better reflect the local angular relationships at each interior knot position. The perpendicular relationship between the computed tangent direction and the angle bisector helps ensure that control points may be positioned at locations that produce appropriate curvature without causing segments to curve excessively away from the intended path between adjacent knots. The elimination of self-intersections and loops contributes to improved visual quality and computational stability in applications that rely on well-behaved curve geometry for rendering, path planning, or motion control purposes.

The composite curve may be rendered in a graphical user interface that provides visual feedback during interactive curve design and editing operations. The rendering process converts the parametric Bézier segment definitions into pixel-based representations that display the smooth curve geometry on computer displays or other visual output devices. The graphical user interface may support real-time preview capabilities that update the composite curve display as users modify knot positions or adjust curve parameters, enabling interactive design workflows that benefit from immediate visual feedback. The rendering operations utilize standard graphics processing techniques that convert the control point and knot position data into displayable curve representations without requiring specialized processing capabilities beyond conventional vector graphics rendering systems.

The composite curve data may be encoded in a scalable vector graphics file format or other vector graphics file formats that preserve the mathematical precision of the curve geometry for subsequent use in various applications and workflows. The scalable vector graphics encoding stores the knot positions and computed control points in standardized data structures that maintain the parametric curve definitions while supporting interchange between different graphics software systems. The file format encoding enables the composite curve to be saved, transmitted, and loaded by various vector graphics applications without loss of geometric accuracy or curve smoothness characteristics. The scalable vector graphics representation supports resolution-independent rendering that maintains curve quality across different display scales and output devices, making the encoded curves suitable for applications ranging from screen display to high-resolution printing and manufacturing processes. The vector graphics file format may include additional metadata that preserves the original knot sequence and tangent calculation parameters for subsequent editing operations.

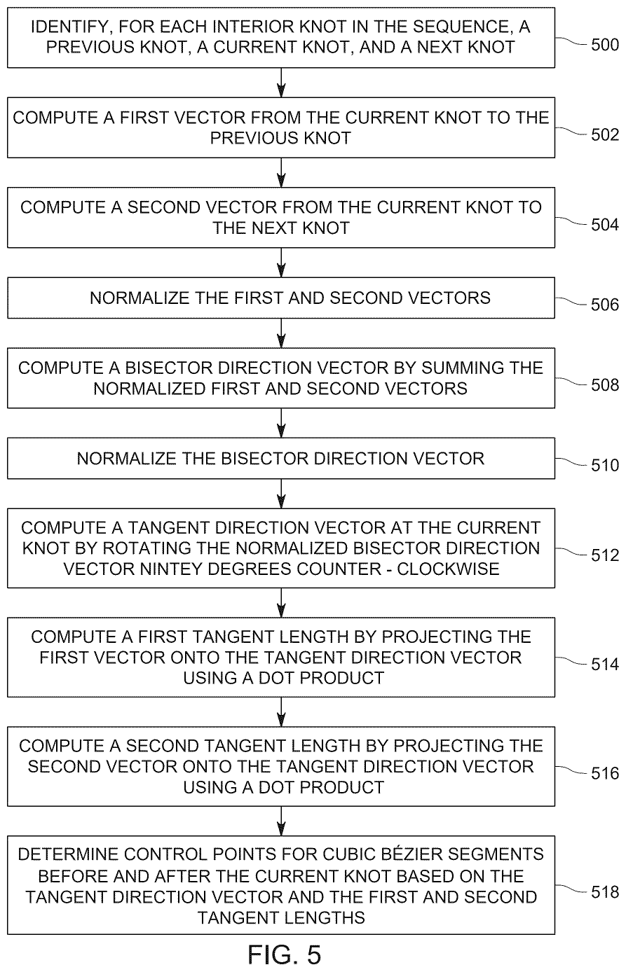

FIG. 5 illustrates a flow chart of the techniques for defining control points for a cubic Bézier spline at each interior knot in a sequence of knots according to various embodiments. The flow chart provides a comprehensive algorithmic framework that guides the implementation of the disclosed spline interpolation method through a series of sequential processing operations. The method may be implemented in software, firmware, or hardware configured to process a series of user-specified points in two-dimensional space and generate a smooth interpolating curve composed of cubic Bézier segments. The algorithmic flow demonstrates how the angle bisector-based tangent calculation approach may be systematically applied to transform input knot sequences into well-behaved composite curves that avoid the geometric distortions associated with conventional spline interpolation techniques.

The method execution begins with a step 500 that includes identifying, for each interior knot in the sequence, a previous knot, a current knot, and a next knot. The step 500 establishes the local geometric context for tangent computation by defining the three-point configuration that provides the directional information for angle bisector calculation. Each knot may be defined by coordinate location in two-dimensional space, such as an (x,y) pair that specifies the position within the coordinate system. The input sequence of knots may be user-specified through interactive operations such as clicking or dragging within a graphical design application, allowing users to define curve geometry through direct point placement. The current knot refers to the knot position where tangent direction and Bézier control points are to be computed, while the previous knot and the next knot represent the immediately adjacent points in the sequence that provide the geometric context for tangent calculation. The method iterates over each interior knot in the sequence, excluding the first and last points when no prior or next knot exists, ensuring that tangent computation occurs only at positions where complete three-point configurations are available.

The algorithmic flow continues with a step 502 that includes computing a first vector from the current knot to the previous knot. The step 502 establishes the directional relationship between the current knot position and the preceding point in the sequence, capturing both the direction and magnitude of the incoming segment at the current knot. The first vector may be expressed as the difference between the coordinate positions of the two points, such as (xₚᵣₑᵥ−x_{curr}, yₚᵣₑᵥ−y_{curr}), where the subscripts indicate the respective knot positions in the sequence. The vector computation provides the geometric foundation for understanding the directional characteristics of the curve segment that approaches the current knot from the previous knot position. The first vector represents the raw geometric relationship between adjacent knots without normalization or other processing operations that might alter the magnitude information contained in the original knot spacing.

A step 504 includes computing a second vector from the current knot to the next knot, establishing the directional relationship between the current knot position and the following point in the sequence. The step 504 captures the direction and magnitude of the outgoing segment at the current knot, providing the complementary directional information that completes the geometric context for angle bisector calculation. The second vector may be computed analogously to the first vector, expressed as the coordinate difference (xₙₑₓₜ−x_{curr},yₙₑₓₜ−y_{curr}) that represents the geometric relationship between the current knot and the next knot in the sequence. The pair of vectors computed in the step 502 and the step 504 defines the angular context at the current knot position, establishing the directional framework that guides subsequent tangent computation and control point placement operations. The vector pair captures the local geometric configuration that influences the curvature characteristics of the Bézier segments that connect adjacent knots in the sequence.

The method proceeds with a step 506 that includes normalizing the first and second vectors to isolate directional information from magnitude considerations. The step 506 ensures that both vectors have unit length, creating standardized directional representations that enable accurate angle bisector computation without distortion from magnitude variations. Normalization operations convert each vector to unit length by dividing the vector components by the vector magnitude, producing normalized vectors that preserve directional characteristics while eliminating the influence of knot spacing variations on subsequent calculations. The normalization process may be expressed mathematically as dividing each vector by its Euclidean norm, such as

$$\frac{\vec{v}}{\vert \vec{v} \vert} ,$$

where \vec{v} represents the original vector and |\vec{v}| represents the vector magnitude. In some cases, the method may be configured to detect when either vector is a zero vector, such as when the current knot overlaps with the previous knot or the next knot, and apply an alternative tangent calculation method to avoid division by zero conditions that could cause computational errors. The alternative tangent calculation method may include using a default tangent direction, interpolating from adjacent knots, or applying a fallback geometric approach that maintains curve continuity.

A step 508 includes computing a bisector direction vector by summing the normalized first and second vectors, creating the geometric foundation for the improved tangent calculation approach. The step 508 generates a vector that points in the direction of the angle bisector between the incoming and outgoing directions at the current knot, representing the directional midpoint between the normalized input vectors. The sum of the two unit vectors yields a new vector that reflects the angular relationship between adjacent segments, providing a reference direction that accounts for the geometric context at the current knot position. The bisector direction vector captures the angular characteristics of the local knot configuration, forming the basis for tangent direction computation that better reflects the geometric relationships between adjacent curve segments compared to conventional approaches that ignore angular considerations.

The algorithmic flow includes a step 510 that includes normalizing the bisector direction vector to ensure that the magnitude does not distort subsequent computation operations. The step 510 applies normalization to the bisector direction vector to create a unit vector that maintains the bisector direction while providing a standardized magnitude for rotation operations. Normalization of the bisector vector ensures that the rotated result maintains appropriate scaling characteristics without unintentional magnitude distortions that could affect the relative lengths of the Bézier control handles. The normalized bisector direction vector provides a stable geometric reference that supports consistent tangent direction computation across various knot configurations and spacing patterns. The normalization operation creates a unit vector that preserves the angular bisector characteristics while enabling predictable rotation transformations that generate tangent directions with appropriate directional properties.

A step 512 includes computing a tangent direction vector at the current knot by rotating the normalized bisector direction vector ninety degrees counter-clockwise. The step 512 applies a geometric transformation that creates a direction perpendicular to the angle bisector, establishing the tangent direction that guides control point positioning for adjacent Bézier segments. The rotation operation may be implemented by applying a standard transformation matrix to the normalized bisector vector, specifically mapping a vector (x,y) to (−y, x) to achieve the ninety-degree counter-clockwise rotation. In alternative embodiments, the rotation angle may be adjusted between 45 and 135 degrees to provide flexibility in tangent direction computation while maintaining a substantially perpendicular relationship to the bisector direction. The resulting tangent vector lies orthogonal to the bisector direction and provides a tangent direction that reflects the angular relationship between the previous knot and the next knot at the current knot position. The perpendicular relationship between the tangent direction and the angle bisector helps ensure that the computed tangent direction accommodates the local geometric configuration while maintaining appropriate directional characteristics for smooth curve generation.

The method continues with a step 514 that includes computing a first tangent length by projecting the first vector onto the tangent direction vector using a dot product operation. The step 514 determines the component of the first vector that aligns with the computed tangent direction, providing a scalar length value that reflects the geometric relationship between the incoming segment direction and the tangent direction. The dot product operation yields a scalar value that represents the extent to which the first vector corresponds to the tangent direction, capturing the directional alignment between the original knot-to-knot vector and the computed tangent orientation. The first tangent length determines the distance along the tangent direction where the first control point may be positioned, establishing the length of the control handle that influences the curvature of the incoming Bézier segment. The projection calculation provides a length measurement that reflects the geometric relationship between the previous knot and the current knot within the context of the computed tangent direction, ensuring that control point positioning accounts for local spacing and directional characteristics.

A step 516 includes computing a second tangent length by projecting the second vector onto the tangent direction vector using a dot product operation, mirroring the projection calculation performed for the first vector. The step 516 determines the component of the second vector that corresponds to the tangent direction, generating a scalar length value that reflects the geometric relationship between the outgoing segment direction and the computed tangent direction. The projection of the second vector provides a length measurement that captures the directional alignment between the vector from the current knot to the next knot and the tangent direction framework. The second tangent length establishes the distance along the tangent direction where the second control point may be positioned, defining the length of the control handle that affects the curvature of the outgoing Bézier segment. The dot product calculation ensures that the second tangent length accounts for the geometric relationship between the current knot and the next knot as expressed through the tangent direction, creating control handle lengths that maintain proportional relationships to the underlying geometric configuration.

The algorithmic flow concludes with a step 518 that includes determining control points for cubic Bézier segments before and after the current knot based on the tangent direction vector and the first and second tangent lengths. The step 518 combines the computed tangent direction with the projection-derived lengths to establish precise positions for control points that define the curvature characteristics of adjacent Bézier segments. The first control point and the second control point may be positioned by scaling the tangent direction vector by the respective projection lengths and adding the resulting vectors to the current knot location, creating control point coordinates that extend from the current knot in the tangent direction by the computed tangent lengths. The control point positioning operation places the first control point at a location that influences the curvature of the curve segment approaching the current knot, while the second control point affects the curvature of the curve segment departing from the current knot. The positioned control points enable the generation of cubic Bézier segments that connect adjacent knots while maintaining smooth curvature characteristics derived from the angle bisector-based tangent calculation, avoiding the self-intersecting loops and excessive curvature variations associated with conventional tangent estimation approaches.

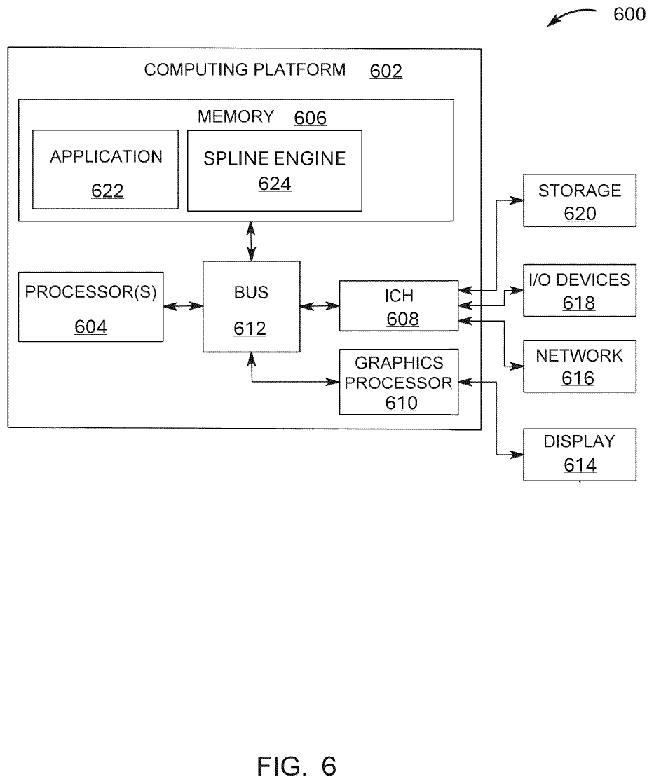

FIG. 6 illustrates a computing system suitable for implementing the spline interpolation methods according to various embodiments. The computing system architecture provides the hardware and software foundation for executing the angle bisector-based tangent calculation algorithms and generating smooth cubic Bézier curves through sequences of user-specified knots. The system components work together to process geometric calculations, manage data structures, and provide interactive capabilities for curve design and editing applications.

A computing system encompasses the complete hardware and software environment configured to perform the disclosed spline interpolation operations. The computing system provides the computational resources and architectural framework for processing knot sequences, computing tangent directions, and generating control points for cubic Bézier segments. The computing system may be implemented as a desktop computer, workstation, mobile device, or distributed computing environment that supports vector graphics applications and interactive design software. The computing system includes both hardware components that provide processing capabilities and software components that implement the mathematical algorithms for curve generation.

A computing platform 602 forms the core hardware foundation of the computing system 600, providing the physical components that execute instructions and manage data processing operations. The computing platform 602 includes processing units, memory systems, and input/output interfaces that support the computational requirements of spline interpolation algorithms. The computing platform 602 may be configured as a single-board computer, multi-processor system, or distributed computing cluster depending on the performance requirements and application context. The computing platform 602 provides the hardware infrastructure that enables real-time curve generation and interactive editing capabilities for graphics applications.

A processor 604 serves as the primary computational engine within the computing platform 602, executing instructions that implement the disclosed spline interpolation methods. The processor 604 may comprise one or more central processing units configured to perform arithmetic operations, logical comparisons, and data manipulation tasks associated with vector calculations, normalization operations, and control point determination. The processor 604 executes software instructions stored in memory to identify interior knots in sequences, compute directional vectors between adjacent knots, and calculate angle bisectors that guide tangent direction computation. The processor 604 performs dot product operations that project vectors onto tangent directions, generating the scalar length values that position control points for cubic Bézier segments. The processor 604 may include multiple processing cores that enable parallel execution of tangent calculations across different knots in a sequence, improving performance for complex curve generation tasks. The multiple processing cores may be configured to compute tangent directions for different interior knots simultaneously, distributing the computational workload and reducing overall processing time for large knot sequences.

A memory 606 provides data storage and instruction storage capabilities that support the execution of spline interpolation algorithms by the processor 604. The memory 606 stores instructions that define the mathematical operations for computing normalized vectors, angle bisectors, and perpendicular tangent directions at interior knot positions. The memory 606 includes a data structure configured to store control points generated through the disclosed tangent calculation methods, maintaining the geometric information that defines cubic Bézier segments connecting adjacent knots. The memory 606 may comprise volatile memory components such as random access memory that provide high-speed access to frequently used data structures, as well as non-volatile memory components that preserve curve data and application settings across system power cycles. The memory 606 stores coordinate information for knot sequences, intermediate calculation results such as normalized vectors and bisector directions, and final control point positions that define the curvature characteristics of generated Bézier segments.

A graphics processor 610 provides specialized processing capabilities for rendering vector graphics and managing visual display operations associated with curve generation and editing applications. The graphics processor 610 may be configured to accelerate the computation of tangent directions and control point positions through parallel processing architectures that distribute calculations across multiple processing units. The graphics processor 610 processes the control point data stored in the memory 606 to generate visual representations of composite Bézier curves that interpolate through specified knot sequences. The graphics processor 610 may include optimized memory structures for storing intermediate vectors and transformation matrices in cache memory, enabling efficient access to frequently used geometric data during curve generation operations. The graphics processor 610 supports hardware acceleration of the mathematical operations associated with vector normalization, dot product calculations, and coordinate transformations that position control points along computed tangent directions. The acceleration capabilities of the graphics processor 610 may significantly improve performance for real-time curve generation and interactive editing applications.

A display 614 provides visual output capabilities that enable users to view generated curves and interact with curve design applications. The display 614 receives processed graphics data from the graphics processor 610 and presents visual representations of composite Bézier curves that demonstrate the smooth interpolation characteristics achieved through the disclosed tangent calculation methods. The display 614 supports real-time rendering of curve modifications as users adjust knot positions or modify curve parameters, providing immediate visual feedback that facilitates interactive design workflows. The display 614 may present curves in various zoom levels and viewing scales, enabling users to examine both overall curve characteristics and detailed geometric features near individual knots. The display 614 renders the composite Bézier curve in a graphical user interface that allows users to input sequences of knots in two-dimensional space and observe the resulting smooth curve generation.

An input/output control hub 608 manages communication between the processor 604 and various peripheral devices that support user interaction and data exchange operations. The input/output control hub 608 facilitates connections to external devices and interfaces that enable users to specify knot positions, adjust curve parameters, and export generated curve data to various file formats. The input/output control hub 608 coordinates data transfer operations between the memory 606 and external storage devices, enabling the preservation and retrieval of curve designs and application settings. The input/output control hub 608 manages the flow of user input data from interactive devices to the processor 604, enabling real-time response to knot placement operations and parameter adjustments during curve design sessions.

A bus 612 provides the communication infrastructure that connects the various hardware components within the computing platform 602, enabling data transfer and coordination between processing units, memory systems, and input/output interfaces. The bus 612 carries instruction data from the memory 606 to the processor 604, enabling the execution of spline interpolation algorithms and curve generation operations. The bus 612 transfers geometric data such as knot coordinates, computed vectors, and control point positions between the processor 604 and the memory 606 during curve calculation processes. The bus 612 facilitates communication between the processor 604 and the graphics processor 610, enabling the transfer of control point data for rendering operations and visual display generation. The bus 612 may comprise multiple communication channels that support simultaneous data transfers between different system components, improving overall system performance during complex curve generation tasks.

Input/output devices 618 provide user interface capabilities that enable interactive specification of knot sequences and adjustment of curve generation parameters. The input/output devices 618 may include pointing devices such as computer mice or touchpads that allow users to specify knot positions through clicking or dragging operations within graphics applications. The input/output devices 618 may comprise keyboards that enable users to enter numeric coordinate values for precise knot positioning or to adjust scalar parameters that influence tangent length calculations. The input/output devices 618 support the graphical user interface that allows users to input sequences of knots in two-dimensional space, with the system responding through real-time curve generation and display updates as knot positions are modified or added to the sequence. The input/output devices 618 enable users to interact with curve editing applications that utilize the disclosed spline interpolation methods to generate smooth composite curves through specified knot sequences.

A network interface 616 provides connectivity capabilities that enable the computing system 600 to communicate with remote systems and access distributed computing resources for curve generation operations. The network interface 616 may support the transmission of curve data to remote rendering systems or the retrieval of knot sequence data from networked storage systems. The network interface 616 enables the computing system 600 to participate in distributed processing arrangements where curve generation tasks may be distributed across multiple computing platforms to improve performance for complex geometric calculations. The network interface 616 may facilitate the exchange of curve data with other graphics applications or design systems, enabling collaborative workflows and data sharing between different software environments.

Storage 620 provides persistent data storage capabilities that preserve curve designs, knot sequences, and application settings across system power cycles and user sessions. The storage 620 maintains libraries of curve templates and knot configurations that users may retrieve and modify for new design projects. The storage 620 preserves the control point data generated through the disclosed tangent calculation methods, enabling users to save and reload curve designs without loss of geometric accuracy or smoothness characteristics. The storage 620 may store curve data in scalable vector graphics file formats that maintain the mathematical precision of control point positions and enable interchange with other vector graphics applications. The storage 620 supports batch processing capabilities that enable efficient conversion of existing curve data to the improved representation provided by the disclosed spline interpolation methods.

An application 622 resides within the memory 606 and provides the software framework for implementing curve design and editing capabilities that utilize the disclosed spline interpolation methods. The application 622 may comprise graphics editing tools, animation software, vector drawing applications, or computer-aided design systems that generate smooth curve interpolation through user-specified points. The application 622 manages user interactions with knot placement operations and parameter adjustments, coordinating with the processor 604 to execute the mathematical algorithms that compute tangent directions and control point positions. The application 622 provides the user interface components that enable interactive curve design, including tools for adding, removing, and repositioning knots within curve sequences. The application 622 coordinates with the graphics processor 610 to render visual representations of generated curves and provide real-time feedback during curve editing operations.

A spline engine 624 implements the core mathematical algorithms and data management operations that perform the disclosed spline interpolation methods within the memory 606. The spline engine 624 executes the sequential processing operations that identify interior knots, compute directional vectors, calculate angle bisectors, and determine control point positions for cubic Bézier segments. The spline engine 624 manages the geometric calculations that normalize vectors, compute dot products for projection operations, and apply rotation transformations to generate perpendicular tangent directions. The spline engine 624 comprises specialized modules that organize the various computational tasks associated with curve generation into discrete functional components. A vector computation module within the spline engine 624 efficiently calculates and normalizes directional vectors between knots, providing the geometric foundation for subsequent angle bisector calculations. A bisector calculation module determines the angle bisector between incoming and outgoing segments at each interior knot, establishing the reference direction for tangent computation. A tangent generation module performs the ninety-degree rotation operations that establish perpendicular tangent directions from the computed angle bisectors. A projection module computes tangent lengths through dot product operations that project original vectors onto the computed tangent directions. A control point determination module positions Bézier control handles based on computed tangents and projection lengths, establishing the geometric parameters that define cubic Bézier segments. A curve construction module assembles individual cubic Bézier segments into continuous composite curves for rendering and export operations.

The processor 604 may be operatively coupled to the memory 606 and configured to execute the instructions stored within the spline engine 624 to perform the complete sequence of operations that define control points for cubic Bézier splines at each interior knot in a sequence of knots. The processor 604 executes instructions to identify, for each interior knot in a sequence of knots, the previous knot, the current knot, and the next knot that establish the local geometric context for tangent calculation. The processor 604 computes a first vector from the current knot to the previous knot and a second vector from the current knot to the next knot, establishing the directional relationships that guide angle bisector computation. The processor 604 normalizes the first and second vectors to isolate directional information from magnitude considerations, enabling accurate geometric calculations that are independent of knot spacing variations. The processor 604 computes a bisector direction vector by summing the normalized first and second vectors, creating the geometric foundation for improved tangent direction calculation. The processor 604 normalizes the bisector direction vector to ensure consistent magnitude characteristics for subsequent rotation operations.

The processor 604 computes a tangent direction vector at the current knot by rotating the normalized bisector direction vector ninety degrees counter-clockwise, establishing the perpendicular direction that guides control point positioning. The processor 604 may be configured to compute the tangent direction vector by applying a transformation that maps a vector (x, y) to (−y, x) to rotate the normalized bisector direction vector ninety degrees counter-clockwise. The processor 604 computes a first tangent length by projecting the first vector onto the tangent direction vector using a dot product operation, determining the scalar value that positions the first control point along the tangent direction. The processor 604 computes a second tangent length by projecting the second vector onto the tangent direction vector using a dot product operation, establishing the scalar value that positions the second control point. The processor 604 determines control points for cubic Bézier segments before and after the current knot based on the tangent direction vector and the first and second tangent lengths, completing the geometric calculations that define smooth curve segments.

The processor 604 may be further configured to generate cubic Bézier segments before and after the current knot based on the control points computed through the disclosed tangent calculation methods. The processor 604 may generate a composite Bézier curve connecting the Bézier segments by repeating the control point determination operations for each interior knot in the sequence, creating continuous curves that interpolate through all specified knot positions. The composite Bézier curve generated by the processor 604 does not include self-intersections or loops near the knots, demonstrating the geometric advantages of the angle bisector-based tangent calculation approach. The processor 604 may be configured to scale the first and second tangent lengths by a user-defined scalar parameter, providing interactive control over curve tightness and curvature characteristics. The processor 604 may be configured to equalize the first and second tangent lengths to a lesser of the first and second tangent lengths, creating symmetric control handle configurations that produce balanced curvature characteristics. The processor 604 may encode the composite Bézier curve in a scalable vector graphics file format, preserving the mathematical precision of the curve geometry for subsequent use in various applications and workflows.

The disclosed method may be enhanced through various performance optimization techniques. Hardware acceleration using graphics processing units provides substantial performance improvements through parallel processing architectures, where tangent computation operations are parallelized across multiple GPU cores. Optimized memory structures store intermediate vectors and transformation matrices in GPU cache memory, improving data access efficiency during parallel processing operations.

Cache management systems may store frequently used normalized vectors, bisector directions, and tangent computations to avoid redundant calculations during interactive editing sessions. Incremental processing capabilities enable the system to update only affected segments when individual knots are modified, maintaining real-time responsiveness. The system may maintain a dependency graph that tracks which segments require recalculation when specific knots change, providing algorithmic foundation for incremental computation optimization.

Control point calculation may be deferred until rendering or export operations, reducing memory consumption during interactive editing sessions. Hierarchical level-of-detail representations enable efficient rendering at multiple zoom levels by computing simplified curves for distant views while maintaining full geometric detail for close examination. Application programming interfaces may expose the method's functionality to third-party developers, while batch processing capabilities enable efficient conversion of existing curve data and processing of large knot sequences.

The disclosed spline interpolation method may be, in some embodiments, extended to three-dimensional space by applying the tangent computation technique to three-dimensional paths. Extension to three-dimensions maintains the fundamental geometric principles while accommodating the additional spatial dimension. In this embodiment, the method processes sequences of knots defined by three-dimensional coordinate positions, such as (x, y, z) triplets that specify locations within a three-dimensional coordinate system. The three-dimensional implementation computes directional vectors between adjacent knots using three-component vector arithmetic, where the first vector from the current knot to the previous knot may be expressed as (xₚᵣₑᵥ−x_{curr}, yₚᵣₑᵥ−y_{curr}, Zₚᵣₑᵥ−Z_{curr}) and the second vector from the current knot to the next knot may be computed as (xₙₑₓₜ−x_{curr}, Yₙₑₓₜ−y_{curr}, zₙₑₓₜ−z_{curr}). The normalization operations for three-dimensional vectors utilize the three-dimensional Euclidean norm |\vec{v}|=\sqrt{x²+y²+z²} to create unit vectors that preserve directional characteristics. The angle bisector computation follows the same summation approach, while rotation operations utilize cross product calculations to generate perpendicular directions within the plane defined by the incoming and outgoing vectors.

The method disclosed herein may also incorporate temporal transformations for animated vector graphics by including time as a parameter and allowing control points to vary smoothly over time while maintaining C¹ continuity at each frame. This embodiment treats time as an additional parameter that influences knot positions, enabling creation of animated sequences where curve geometry evolves smoothly. The temporal implementation may interpolate between different knot configurations at specified keyframes, applying temporal smoothing functions to ensure smooth animated curves.

The system may also incorporate perceptual metrics to optimize visual quality by including feedback mechanisms that evaluate visual smoothness using predetermined perceptual criteria. The perceptual optimization approach recognizes that mathematical smoothness measures may not always correspond directly to human visual perception, leading to evaluation criteria that better reflect user perception of curve quality. The system may be deployed in cloud-based environments providing scalable computational resources and centralized processing capabilities for complex spline interpolation operations.

The present disclosure provides a method of defining control points for a cubic Bézier spline at each interior knot in a sequence of knots. The method includes identifying, for each interior knot in the sequence, a previous knot, a current knot, and a next knot. The method further includes computing a first vector from the current knot to the previous knot, computing a second vector from the current knot to the next knot, and normalizing the first and second vectors. Additionally, the method includes computing a bisector direction vector by summing the normalized first and second vectors, normalizing the bisector direction vector, and computing a tangent direction vector at the current knot by rotating the normalized bisector direction vector ninety degrees counter-clockwise. The method also includes computing a first tangent length by projecting the first vector onto the tangent direction vector using a dot product, computing a second tangent length by projecting the second vector onto the tangent direction vector using a dot product, and determining control points for cubic Bézier segments before and after the current knot based on the tangent direction vector and the first and second tangent lengths.

In other embodiments, the method further includes generating cubic Bézier segments before and after the current knot based on the control points. The method may also include generating a composite Bézier curve connecting the Bézier segments by repeating the method for each interior knot in the sequence. In such embodiments, the composite Bézier curve does not include self-intersections or loops near the knots.

In further embodiments, the previous knot, current knot, and next knot are defined by user-specified coordinates in a two-dimensional space. Computing the tangent direction vector may comprise applying a transformation that maps a vector (x,y) to (−y,x) to rotate the normalized bisector direction vector ninety degrees counter-clockwise.

In additional embodiments, the method further includes scaling the first and second tangent lengths by a user-defined scalar parameter. Alternatively, the method may include equalizing the first and second tangent lengths to a lesser of the first and second tangent lengths.

In some embodiments, the composite Bézier curve is rendered in a graphical user interface. In other embodiments, the composite Bézier curve is encoded in a scalable vector graphics file format.

The present disclosure also provides a computing system comprising a memory storing instructions and a data structure configured to store control points, and a processor operatively coupled to the memory and configured to execute the instructions. The processor is configured to identify, for each interior knot in a sequence of knots, a previous knot, a current knot, and a next knot. The processor is further configured to compute a first vector from the current knot to the previous knot, compute a second vector from the current knot to the next knot, and normalize the first and second vectors. Additionally, the processor is configured to compute a bisector direction vector by summing the normalized first and second vectors, normalize the bisector direction vector, and compute a tangent direction vector at the current knot by rotating the normalized bisector direction vector ninety degrees counter-clockwise. The processor is also configured to compute a first tangent length by projecting the first vector onto the tangent direction vector using a dot product, compute a second tangent length by projecting the second vector onto the tangent direction vector using a dot product, and determine control points for cubic Bézier segments before and after the current knot based on the tangent direction vector and the first and second tangent lengths.

In other embodiments of the computing system, the processor is further configured to generate cubic Bézier segments before and after the current knot based on the control points. The processor may also be configured to generate a composite Bézier curve connecting the Bézier segments by repeating the control point determination for each interior knot in the sequence. In such embodiments, the composite Bézier curve does not include self-intersections or loops near the knots.

In further embodiments of the computing system, the previous knot, current knot, and next knot are defined by user-specified coordinates in a two-dimensional space. The processor may be configured to compute the tangent direction vector by applying a transformation that maps a vector (x,y) to (−y,x) to rotate the normalized bisector direction vector ninety degrees counter-clockwise.

In additional embodiments of the computing system, the processor is further configured to scale the first and second tangent lengths by a user-defined scalar parameter. Alternatively, the processor may be configured to equalize the first and second tangent lengths to a lesser of the first and second tangent lengths.

In some embodiments of the computing system, the processor is further configured to render the composite Bézier curve in a graphical user interface. In other embodiments, the processor is further configured to encode the composite Bézier curve in a scalable vector graphics file format.

Machine readable storage including machine-readable instructions, when executed, to implement a method or realize a computing system in any of the examples of the present application.

Various techniques, or certain aspects or portions thereof, may take the form of program code (i.e., instructions) embodied in tangible media, such as floppy diskettes, CD-ROMs, hard drives, a non-transitory computer readable storage medium, or any other machine-readable storage medium wherein, when the program code is loaded into and executed by a machine, such as a computer, the machine becomes a computing system for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or an interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present subject matter. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present subject matter may be referred to herein along with alternatives for the various components thereof. It is understood that such embodiments, examples, and alternatives are not to be construed as de facto equivalents of one another, but are to be considered as separate and autonomous representations of the present subject matter.

Although the foregoing has been described in some detail for purposes of clarity, it will be apparent that certain changes and modifications may be made without departing from the principles thereof. It should be noted that there are many alternative ways of implementing both the processes and computing systems described herein. Accordingly, the present embodiments are to be considered illustrative and not restrictive, and the subject matter is not to be limited to the details given herein, but may be modified within the scope and equivalents of the appended claims.

Those having skill in the art will appreciate that many changes may be made to the details of the above-described embodiments without departing from the underlying principles of the subject matter. The scope of the present subject matter should, therefore, be determined only by the following claims.

1. A method of defining control points for a cubic Bézier spline at each interior knot in a sequence of knots, comprising:
identifying, for each interior knot in the sequence, a previous knot, a current knot, and a next knot;
computing a first vector from the current knot to the previous knot;
computing a second vector from the current knot to the next knot;
normalizing the first and second vectors;
computing a bisector direction vector by summing the normalized first and second vectors;
normalizing the bisector direction vector; computing a tangent direction vector at the current knot by rotating the normalized bisector direction vector ninety degrees counter-clockwise;
computing a first tangent length by projecting the first vector onto the tangent direction vector using a dot product; computing a second tangent length by projecting the second vector onto the tangent direction vector using a dot product; and
determining control points for cubic Bézier segments before and after the current knot based on the tangent direction vector and the first and second tangent lengths.

2. The method of claim 1, further comprising generating cubic Bézier segments before and after the current knot based on the control points.

3. The method of claim 2, further comprising generating a composite Bézier curve connecting the Bézier segments by repeating the method for each interior knot in the sequence.

4. The method of claim 3, wherein the composite Bézier curve does not include self-intersections or loops near the knots.

5. The method of claim 1, wherein the previous knot, current knot, and next knot are defined by user-specified coordinates in a two-dimensional space.

6. The method of claim 1, wherein computing the tangent direction vector comprises applying a transformation that maps a vector (x,y) to (−y,x) to rotate the normalized bisector direction vector ninety degrees counter-clockwise.

7. The method of claim 1, further comprising scaling the first and second tangent lengths by a user-defined scalar parameter.

8. The method of claim 1, further comprising equalizing the first and second tangent lengths to a lesser of the first and second tangent lengths.

9. The method of claim 1, wherein the previous knot, current knot, and next knot are defined by three-dimensional coordinates and the first and second vectors comprise three-dimensional vectors.

10. The method of claim 1, further comprising: detecting when at least one of the first or second vectors is a zero vector; and applying an alternative tangent calculation method when the zero vector is detected.

11. A computing system, comprising:
a memory storing instructions and a data structure configured to store control points; and
a processor operatively coupled to the memory and configured to execute the instructions to:
identify, for each interior knot in a sequence of knots, a previous knot, a current knot, and a next knot;
compute a first vector from the current knot to the previous knot; compute a second vector from the current knot to the next knot;
normalize the first and second vectors;
compute a bisector direction vector by summing the normalized first and second vectors; normalize the bisector direction vector;
compute a tangent direction vector at the current knot by rotating the normalized bisector direction vector ninety degrees counter-clockwise;
compute a first tangent length by projecting the first vector onto the tangent direction vector using a dot product;
compute a second tangent length by projecting the second vector onto the tangent direction vector using a dot product; and
determine control points for cubic Bézier segments before and after the current knot based on the tangent direction vector and the first and second tangent lengths.

12. The computing system of claim 11, wherein the processor is further configured to generate cubic Bézier segments before and after the current knot based on the control points.

13. The computing system of claim 12, wherein the processor is further configured to generate a composite Bézier curve connecting the Bézier segments by repeating the control point determination for each interior knot in the sequence.

14. The computing system of claim 13, wherein the composite Bézier curve does not include self-intersections or loops near the knots.

15. The computing system of claim 11, wherein the processor comprises multiple processing cores configured to compute tangent directions for different interior knots in parallel.

16. The computing system of claim 11, further comprising a graphics processor configured to accelerate computation of the tangent directions and control point positions.

17. The computing system of claim 11, wherein the processor is configured to scale the first and second tangent lengths by a user-defined scalar parameter.

18. The computing system of claim 11, wherein the processor is configured to equalize the first and second tangent lengths to a lesser of the first and second tangent lengths.

19. The computing system of claim 11, wherein the previous knot, current knot, and next knot are defined by three-dimensional coordinates and the first and second vectors comprise three-dimensional vectors.

20. The computing system of claim 11, wherein the processor is further configured to: detect when at least one of the first or second vectors is a zero vector; and apply an alternative tangent calculation method when the zero vector is detected.
